(19) United States
(12) Patent Application Publication
(10) Pub. No.: US 2004/0002551 A1
(43) Pub. Date: Jan. 1, 2004

(54) Colloidal silica composition and production method thereof

(76) Inventors: Keun-Deok Park, (US); Jeong-Hyun Oh, (US); Sang-Jin Lee, (US); Ji-Myung Hyun, (US)

Correspondence Address: CHA & REITER, LLC, 210 ROUTE 4 EAST, PARAMUS, NJ, 07652, US

(21) Appl. No.: 10/607,156

(22) Filed: Jun. 26, 2003

(30) Foreign Application Priority Data
Jun. 27, 2002 (KR) 2002-36289

(51) Int. Cl. C01B 33/141

(52) U.S. Cl. 516/81

(57) ABSTRACT

Disclosed is a colloidal silica composition and a method for producing high-purity silica glass using the same. The colloidal silica composition of the present invention comprise an alkoxysilane compound, an organic solvent, deionized water, and a basic catalyst. The colloidal silica composition further includes a basic organic material for adjusting a hydrogen ion concentration (pH) to prevent the formation of agglomerates when concentrated. Silica glass having high purity and excellent sinterability can be produced using the colloidal silica composition of the present invention.

### CLAIM OF PRIORITY

This application claims priority to an application entitled “COLLOIDAL SILICA COMPOSITION AND PRODUCTION METHOD THEREOF,” filed in the Korean Intellectual Property Office on Jun. 27, 2002 and assigned Serial No. 2002-36289, the contents of which are hereby incorporated by reference.

### BACKGROUND OF THE INVENTION

1. Field of the Invention

The present invention relates to a colloidal silica composition and a production method thereof, and more particularly to a high-concentration colloidal silica composition that has a uniform particle distribution through adjusting a hydrogen ion concentration (pH) to increase the electrically repulsive inter-particle forces, thus preventing the formation of agglomerates when colloidal silica is composition is concentrated to a high concentration, and a method for producing a high-purity silica glass using the same.

2. Description of the Related Art

In general, silica glass is transparent, chemically inert, excellent in thermal stability, strength, etc., and has a low thermal expansion rate. Due to these superior characteristics, silica glass is widely employed as an optical fiber preform.

An optical fiber is comprised of an inner core and a cladding, which has a different refractive index from that of the inner core to provide a total refection of light in the core. In order to manufacture such an optical fiber, first of all, an optical fiber preform consisting of a core rod and an over-cladding tube surrounding the core rod is produced. Thereafter, the optical fiber preform is subjected to a heat treatment and then drawn to obtain an optical fiber

This type of optical fiber is generally manufactured by a chemical vapor deposition method. However, the chemical vapor deposition method has drawbacks in that the productivity is low as solid silica glass is produced by a gas phase reaction, and in that production costs are increased due to a high temperature of about 1800° C. and the deployment of expensive equipments required in the process.

Another conventional silica glass production method utilizes a sol-gel process. Since the sol-gel process is a liquid phase process in contrast with other production methods, it has high productivity and enables the composition of products to be freely adjusted. Also, the sol-gel method is very economical because the process is generally conducted at a low temperature. Furthermore, based upon the use of high-purity material from a starting material stage, it is very useful in producing silica glass with which high-purity glass products such as photo masks for the fabrication of semiconductors and optical fibers are made.

Briefly, the method for producing silica glass using the sol-gel process uses silicon alkoxysilane or fumed silica as starting material. First, a production method of silica glass using alkoxysilane is performed. To this end, a solvent such as alcohol, water or the like is added to alkoxysilane to cause a hydrolysis reaction. At this time, if the hydrolysis reaction is conducted in the presence of an acidic catalyst, a chemically bridged integral gel is obtained, whereas if the hydrolysis reaction is conducted in the presence of a basic catalyst, a spherical colloidal silica sol is obtained. Subsequently, the resulting reaction product from the hydrolysis of alkoxysilane is injected into a forming mold, and molding is conducted through the mold to form a gel. The structure of the gel is dependent upon relative content ratios of alkoxysilane, alcohol, water, etc. in the hydrolysis reaction of alkoxysilane or a hydrogen ion concentration (pH) of the hydrolysis composition of alkoxysilane. Thereafter, the gel is dried for a predetermined time and then is subjected to a heat treatment at a temperature of 700° C. or higher to obtain a silica glass tube.

A gel formed from an alkoxysilane compound according to the above-mentioned method, however, has a problem in that its contraction ratio after drying step is very high as it suffers a large stress due to small pores arising during the drying process.

Thus, the extent of dryness is adjusted in the drying process by using a special technique, by deintensifying drying conditions (maintaining a relatively lower temperature and a relatively higher humidity) or providing a mold lid with a relatively small-sized hole, to prevent cracks during the drying process and to obtain a high yield.

In spite of taking such measures, not only is a considerable time consumed by the completion of drying process, but also a limitation is put on producing pole-shaped silica glass due to a high contraction ratio.

Another method for producing silica glass using the sol-gel process, i.e., fumed silica material is known. In this method, fumed silica and additives, such as dispersants, plasticizers and the like, are dispersed in deionized water to form a sol. The formed sol is left intact for a predetermined time to be matured. A gelation agent is added to the matured sol, and the resulting sol is poured into a mold to cause gelation of the sol. When the gelation is completed, a gel formed by the gelation is separated from the mold and then dried. Thereafter, the dried gel is subjected to a heat treatment to remove organic materials contained within the gel. Subsequently, a dehydroxylation reaction and a sintering reaction are conducted for the gel, from which organic materials are removed, to produce silica glass.

The above-mentioned production method of pole-shaped silica glass using fumed silica can solve a problem of occurring cracks during the drying process described earlier by employing a relatively larger particle size to lower a contraction ratio and to enlarge a pore size. Consequently, the production method using a large particle size has been recommended as a more preferred choice than the production method using a small particle size.

Although primary particles have the same spherical shape and the same size, in comparison with colloidal silica obtained from the above-mentioned production method using alkoxysilane; however, secondary particles have relatively nonuniform and wide particle size distribution due to factors immanent in the production method. The nonuniform and wide particle distribution of the secondary particles is caused by the thermal coupling between particles during the producing processes and makes it impossible to finely or uniformly pulverize particles in the subsequent process. As such, silica glass produced using fumed silica has a inferior quality to silica glass produced using colloidal silica.

On the other hand, even though using colloidal silica is relatively advantageous in glass quality, it has undesirable characteristics as follows:

Colloidal silica is generally obtained by hydrolyzing a mixture of an alkoxysilane compound such as tetraethylorthosilicate, a basic catalyst such as ammonia water, and ethanol as a solvent in water. In order to obtain a homogeneous phase, colloidal silica is initially produced at a concentration of several to several tens of percentage and then goes through a concentrating process. After the concentrating process, colloidal silica is concentrated to a concentration of 30 to 40% in a case when it has a particle size of about 40 nm. If the concentrating process of colloidal silica progresses in accordance with this manner until its concentration reaches 45% or more, colloidal silica forms agglomerates or loses mobility. A particle size of a colloidal phase to be produced is dependent upon quantity of a catalyst, i.e., ammonia water added at an initial stage, and if the quantity of ammonia water is increased or strongly basic material is used as a catalyst in order to prevent the agglomeration of particles, the particle size grows unnecessarily larger beyond an intended range.

Even though dependent upon a particle size, a concentration of colloidal silica, in a case when colloidal silica has a particle size of 45 nm, must be at least 45%, and preferably at least 46% to secure wet gel's strength in a molding process.

### SUMMARY OF THE INVENTION

Accordingly, the present invention has been made to solve the above-mentioned problems occurring in the prior art and provides additional advantages, by providing a colloidal silica composition that can prevent the formation of agglomerates when concentrated to a high concentration and has uniform particle distribution, and a production method thereof.

One aspect of the present invention is to provide a method for producing silica glass having high purity and excellent sinterability.

According to another aspect of the invention, there is provided a colloidal silica composition comprising: an alkoxysilane compound; an organic solvent; deionized water; and, a basic catalyst, wherein the colloidal silica composition further includes strongly basic organic material for adjusting a hydrogen ion concentration (pH) to prevent the formation of agglomerates when the colloidal silica composition is concentrated.

Preferably, the strongly basic organic material is added to the colloidal silica composition to the extent that the hydrogen ion concentration (pH) of colloidal silica becomes 12 or more.

In accordance with another aspect of the present invention, there is provided a method for producing a colloidal silica composition comprising the steps of: mixing and agitating an alkoxysilane compound, an organic solvent, deionized water, and a basic catalyst to produce colloidal silica; washing the colloidal silica with deionized water to remove byproducts; adding strongly basic organic material to the colloidal silica to adjust a hydrogen ion concentration (pH); and, concentrating the pH-adjusted colloidal silica.

It is preferred that the step of adding the strongly basic organic material to adjust a hydrogen ion concentration is conducted before or after the step of washing the colloidal silica with deionized water to remove byproducts.

In accordance with further another aspect of present invention, there is provided a method for producing silica glass comprising the steps of: mixing and agitating an alkoxysilane compound, an organic solvent, deionized water and a basic catalyst to produce colloidal silica; adding strongly basic organic material to the colloidal silica to adjust a hydrogen ion concentration (pH); concentrating the pH-adjusted colloidal silica until a concentration of the colloidal silica becomes 45% or more; adding ester material to the concentrated colloidal silica; and, injecting and molding the resulting colloidal silica in a mold to cause gelation of the colloidal silica.

### DETAILED DESCRIPTION OF THE PREFERRED EMBODIMENT

Hereinafter, preferred embodiments of the present invention will be described in detail with reference to the accompanying drawings. For the purposes of clarity and simplicity, a detailed description of known functions and configurations incorporated herein will be omitted as it may make the subject matter of the present invention rather unclear.

First, an alkoxysilane compound such as tetraethylorthosilicate andethanol as a solvent (corresponding to 40 times as large as an equivalence ratio of tetraethylorthosilicate) are mixed well together. Deionized water having quantity corresponding to 4 times as large as a chemical equivalence ratio of tetraethylorthosilicate is put in the mixture, while simultaneously ammonia water as a basic catalyst is added at an increment to the mixture, then the resulting solution is agitated. At this time, a particle size of silica to be produced is determined by the quantity of the added deionized water, a reaction temperature, quantity of the catalyst, and so forth. Thus, the ammonia water is added to the extent that a hydrogen ion concentration (pH) of the solution becomes 10.7 to 10.8, and the solution is sufficiently agitated. Accordingly, colloidal silica with a low concentration is obtained.

The colloidal silica produced by the above-mentioned method is concentrated to a high concentration according to any one of two techniques.

In a first technique, the colloidal silica is washed with deionized water to remove an alcohol ingredient, a byproduct of the colloidal silica, and the ammonia water, i.e., the basic catalyst. If the washing process is ended, an alcoholic solvent such as tetraethylammonium hydroxide or tetramethylammonium hydroxide, which is strongly basic material, is added to the colloidal silica to adjust a hydrogen ion concentration (pH) up to 12.0 to 12.8. This adjustment of pH is intended to prevent the formation of agglomerates in a subsequent concentrating process by charging the surfaces of the silica with negative electric charges to generate electrically repulsive interparticle forces.

The adjustment of pH is followed by a concentrating process. The concentrating process is performed using pulp and a molecular sieve, thus results in colloidal silica with a concentration of 45% or more. At this time, the colloidal silica exhibits a pH of 11.0 to 12.0.

In a second technique, tetrarthylammonium hydroxide or tetramethylammonium hydroxide is added to a low-concentration colloidal silica to adjust pH up to 12.0 to 12.8 before a washing process is conducted. This is also intended to prevent the formation of agglomerates in a subsequent concentrating process by charging the surfaces of the silica with negative electric charges to generate electrically repulsive interparticle forces.

Following the adjustment of pH, a concentrating process is performed. After the concentrating process, the concentrated colloidal silica has a pH of 11.0 to 12.0.

In an alternate embodiment, a dispersing device or a ultrasonic device can be additionally used to prevent the formation of agglomerates during the concentrating process.

Colloidal silica produced by the above-mentioned method can be applied in place of a dispersed sol formed using the existing fumed silica to a sol-gel process for producing silica glass. At this time, the same binder, plasticizer and gelation agent as those used in the sol-gel process using the fumed silica can be also used.

### EXAMPLE 1

2 l of tetraethylorthosilicate is put in 10 l of ethanol and the solution is agitated so as to be mixed well. After 0.72 l of water is poured in the solution and the mixture solution is intensively agitated, ammonia water is added at an increment to the agitated solution. The solution, pH of which has been adjusted to 11.7 by the added ammonia water, is further agitated for a time period of 60 minutes until the reaction reaches an equilibrium state.

After the agitation is ended, a washing process is performed in a filtering device provided with a molecular sieve. At this time, washing water is constantly supplied through an injection port so as not to reduce the overall volume of the solution. Following the washing process, the resulting colloidal silica exhibits a pH of 9.7.

Subsequently, tetraethylammonium hydroxide is added to the colloidal silica to adjust pH to 12.7. The pH-adjusted colloidal silica is concentrated to a concentration of 47% in the filtering device provided with the molecular sieve.

Of the colloidal silica with a concentration of 47% produced by the above-mentioned method, 3 kg of colloidal silica is taken. 100 cc of ethyl lactate is added to the 3 kg of colloidal silica and then the ethyl lactate-added colloidal silica is injection-molded in a tubular mold to form a gel.

After the molded gel is dried under a temperature of 30° C. and a humidity of 75%, it is subjected to a heat treatment at a temperature of 600° C. to remove organic materials, and is subjected to another heat treatment at a temperature of 900° C., while a chlorine gas is added to the gel to remove metallic impurities and an OH radical.

Finally, the gel is subjected to a heat treatment at a temperature of 1400° C. to obtain tubular silica glass. As such, the producing process of silica glass is completed.

As described above, the present invention can prevent the formation of agglomerates when colloidal silica is concentrated to a high concentration by adjusting pH of colloidal silica surfaces to generate electrically repulsive interparticle forces. Accordingly, a high-concentration colloidal silica composition having uniform particle distribution can be produced.

In addition, the high-concentration colloidal silica composition having uniform particle distribution in accordance with the present invention makes it possible to produce silica glass having high purity and excellent sinterability.

While the invention has been shown and described with reference to certain preferred embodiments thereof, it will be understood by those skilled in the art that various changes in form and details may be made therein without departing from the spirit and scope of the invention. Accordingly, the scope of the invention should not be limited to the embodiments, but should be defined by the appended claims and equivalents thereof.

What is claimed is:

1. A colloidal silica composition comprising:
an alkoxysilane compound;
an organic solvent;
deionized water; and,
a basic catalyst, wherein the colloidal silica composition further includes a basic organic material for adjusting a hydrogen ion concentration (pH) to prevent the formation of agglomerates when the colloidal silica composition is concentrated.

2. The colloidal silica composition according to claim 1, wherein the basic organic material is added to the colloidal silica composition to the extent that the hydrogen ion concentration (pH) of colloidal silica becomes 12 or more.

3. The colloidal silica composition according to claim 1, wherein the basic catalyst is ammonia water.

4. The colloidal silica composition according to claim 1, wherein the basic organic material is tetraethylammonium hydroxide.

5. A method for producing a colloidal silica composition, the method comprising the steps of:
mixing and agitating an alkoxysilane compound, an organic solvent, deionized water, and a basic catalyst to produce colloidal silica;
washing the colloidal silica with deionized water to remove byproducts;
adding a basic organic material to the colloidal silica to adjust a hydrogen ion concentration (pH); and,
concentrating the pH-adjusted colloidal silica.

6. The method according to claim 5, wherein the step of adding the basic organic material to adjust a hydrogen ion concentration is conducted before or after the step of washing the colloidal silica with deionized water to remove byproducts.

7. The method according to claim 5, wherein the basic organic material is tetraethylammonium hydroxide.

8. The method according to claim 5, wherein the basic catalyst is ammonia water.

9. The method according to claim 5, further comprising the steps of:
adding a predetermined amount of ethyl lactate and a predetermined amount of the pH-adjusted colloidal silica in a tubular mold to form a gel;
drying the molded gel at a predetermined temperature and humidity;
applying a first heat treatment to the dried gel while adding a chlorine gas; and,
applying a second heat treatment to obtain a tubular silica glass.

10. The method according to claim 5, further comprising the step of:
applying a third heat treatment to remove organic materials.

11. A method for producing silica glass comprising the steps of:
mixing and agitating an alkoxysilane compound, an organic solvent, deionized water, and a basic catalyst to produce colloidal silica;
adding a basic organic material to the colloidal silica to adjust a hydrogen ion concentration (pH);
concentrating the pH-adjusted colloidal silica until a concentration of the colloidal silica becomes 45% or more;
adding ester material to the concentrated colloidal silica; and,
injecting and molding the resulting colloidal silica in a mold to cause gelation of the colloidal silica.

12. The method according to claim 11, wherein the basic organic material is added to the colloidal silica composition to the extent that the hydrogen ion concentration (pH) of colloidal silica becomes 12 to 12.8.

13. The method according to claim 11, wherein the basic organic material is tetraethylammonium hydroxide.

14. The method according to claim 11, wherein the basic catalyst is ammonia water.
